(19) United States
(12) Patent Application Publication
(10) Pub. No.: US 2007/0049252 A1
(43) Pub. Date: Mar. 1, 2007

(54) Failure handling during security exchanges between a station and an access point in a WLAN

(75) Inventors: Brian K. Smith, Wellington, FL (US); Mahesh Mutha, Sunrise, FL (US); Imran Raza, Lake Worth, FL (US); Srinath Subramanian, Davie, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/216,307

(22) Filed: Aug. 31, 2005

(51) Int. Cl. H04M 1/66

(52) U.S. Cl. 455/411; 455/41.2

(57) ABSTRACT

A method and a machine readable storage for handling failures during security exchanges between a station (125) having a wireless network adapter (130) and a first access point (110) of a wireless local area network (WLAN) (105). As part of a WLAN association process, the method can include transmitting from the station to the first access point a message including a station identifier (170). A first protocol exchange timer (180) also can be started. Responsive to a timeout of the first protocol exchange timer, an association retry counter can be incremented. The WLAN association process can be restarted if the association retry counter is not greater than a retry counter threshold. If the association retry counter is greater than the retry counter threshold, the wireless network adapter can be commanded to enter sleep mode.

### BACKGROUND OF THE INVENTION

1. Field of the Invention

The present invention generally relates to wireless communications and, more particularly, to failure handling during a security exchange between a station and an access point in a wireless local area network (WLAN).

2. Background of the Invention

The use of wireless local area networks (WLANs) has proliferated in recent years. WLANs are now commonly found in homes, campuses and businesses. Indeed, many coffee houses and fast food providers offer free WLAN use for their customers who have computers, personal digital assistants (PDAs), mobile telephones, or other digital devices which have wireless networking capability (hereinafter referred to as “stations”).

When a station enters WLAN coverage or is initially activated within a WLAN coverage area, a full security exchange is typically performed. In an IEEE 802.11 network, there are generally two types of authentication. The first authentication type is an open system authentication. Open system authentication involves a two-step authentication transaction sequence that takes place between the station and an access point which provides access to the WLAN. The second 802.11 authentication type is a four-step shared key authentication. Shared key authentication supports authentication of stations as either members of those who know a shared secret key or members of those who do not. The secret key is presumed to have been delivered to a participating station via a secure channel that is independent of the 802.11 network.

The basic 802.11 authentication processes have known vulnerabilities. To increase the level of data protection and access control for WLAN systems, the Wi-Fi Alliance, in conjunction with the IEEE, has introduced an enhanced authentication protocol commonly known as Wi-Fi Protected Access (WPA). There are two types of WPA authentication processes which take place between a station and an access point. The first is a full security exchange that takes place when a station first logs onto a WLAN. The full security exchange includes an 802.11 authentication and association, an 802.1× authentication using extensible authentication protocol (EAP) with a preferred authentication type such as transport layer security (EAP-TLS), and a key exchange that includes a four-way handshake and group key handshake.

The second type of WPA authentication process is a truncated security exchange, which is used when the station is handed off from one access point to another. The truncated security exchange includes an 802.11 authentication and re-association, and the key exchange that includes the four-way handshake and the group key handshake. However, the truncated exchange does not include an 802.1× authentication using EAP-TLS, which reduces the amount of time required for the authentication process to complete.

Failures sometimes occur in the security exchange processes, typically resulting in a loss of connection. New network communication technology, such as that incorporated into Motorola's CN620 mobile office device, provides the capability of switching to an alternate communication mode when a security exchange failure occurs. For instance, the station may switch to a global system for mobile communications (GSM) protocol and continue communicating via a GSM network. After a few minutes of GSM operation, the station may be able to switch back to the WLAN, assuming the full security exchange has been successfully completed.

Although toggling to GSM when a security exchange failure occurs is advantageous for maintaining a connection, there are some disadvantages with such toggling. For example, the station may continue transmitting and receiving communication signals on both the WLAN and GSM networks, which consumes valuable battery life. In addition, the station user interface may indicate GSM coverage while excellent WLAN coverage may be available.

Moreover, in some instances, a station may not re-scan for WLAN coverage for a significant amount of time (i.e. 30-60 seconds). Thus, the station may stay on the GSM network longer than necessary, which also has certain disadvantages. For instance, the user may be prevented from launching an enterprise enabled application until WLAN coverage is reestablished.

### SUMMARY OF THE INVENTION

The present invention relates to a method and a machine readable storage for handling failures during security exchanges between a station having a wireless network adapter and a first access point of a wireless local area network (WLAN). As part of a WLAN association process, the method can include transmitting from the station to the first access point a message including a station identifier. A first protocol exchange timer also can be started. Responsive to a timeout of the first protocol exchange timer, an association retry counter can be incremented. The method also can include incrementing the association retry counter in response to receiving a message that includes an association failure identifier or in response to not receiving a response from the first access point.

The WLAN association process can be restarted if the association retry counter is not greater than a retry counter threshold. If the association retry counter is greater than the retry counter threshold, the wireless network adapter can be commanded to enter sleep mode. The wireless network adapter also can be commanded to enter sleep mode in response to receiving an extensible authentication protocol (EAP) failure packet. In addition, the station can attempt to associate with a second communications network in response to receiving the EAP failure packet.

The first protocol exchange timer can be stopped in response to receiving an EAP success packet. Further, a key exchange timer can be started in response to receiving an EAP success packet. If the key exchange timer times out, the association retry counter can be incremented.

As part of a WLAN re-association process between the station and a second access point, a second protocol exchange timer can be started. Responsive to a timeout of the second protocol exchange timer, a re-association retry counter can be incremented. The association process can be restarted if the re-association retry counter is greater than a re-association retry counter threshold. Alternatively, the WLAN re-association process can be re-attempted if the re-association retry counter is not greater than the re-association retry counter threshold.

The method also can include, as part of a WLAN re-association process between the station and a second access point, starting a second protocol exchange timer. Responsive to receiving an extensible authentication protocol over LAN (EAPOL) key packet prior to a timeout of the second protocol exchange timer, a key exchange timer can be started. In response to a timeout of the key exchange timer, a re-association retry counter can be incremented. The association process can be restarted if the re-association retry counter is greater than a re-association retry counter threshold. The WLAN re-association process can be re-attempted if the re-association retry counter is not greater than the re-association retry counter threshold.

The WLAN re-association process between the station and a second access point also can include restarting the association process in response to receiving an EAP failure packet. Further, a re-association retry counter can be incremented in response to a re-association failure. The association process can be restarted if the re-association retry counter is greater than a re-association retry counter threshold. Otherwise, the WLAN re-association process can be re-attempted if the re-association retry counter is not greater than the re-association retry counter threshold.

The present invention also relates to station comprising a wireless network adapter that transmits from the station to a first access point a message comprising a station identifier. The message can be transmitted as part of a WLAN association process. The station also can include a first protocol exchange timer and a processor. The processor can increment an association retry counter responsive to a timeout of the first protocol exchange timer. The processor also can restart the association process if the association retry counter is not greater than a retry counter threshold, and signal the wireless network adapter to enter sleep mode if the association retry counter is greater than the retry counter threshold.

In addition, the processor can increment the association retry counter responsive to receiving a message comprising an association failure identifier, or responsive to not receiving a response from the first access point. The processor also can signal the wireless network adapter to enter sleep mode in response to receiving an EAP failure packet from the first access point.

The station can attempt to associate with a second communications network in response to receiving the EAP failure packet, or the processor can stop the first protocol exchange timer in response to receiving an EAP success packet from the first access point. The processor also can start a key exchange timer in response to receiving an EAP success packet from the first access point. In response to a timeout of the key exchange timer, the processor can increment the association retry counter.

The processor can start a second protocol exchange timer as part of a WLAN re-association process between the station and a second access point. In response to a timeout of the second protocol exchange timer, the processor can increment a re-association retry counter. If the re-association retry counter is greater than a re-association retry counter threshold, the processor can restart the association process. If the re-association retry counter is not greater than the re-association retry counter threshold, the processor can re-attempt the re-association process.

Further, the processor can start a key exchange timer in response to receiving an extensible authentication protocol over LAN (EAPOL) key packet prior to a timeout of the second protocol exchange timer. In response to a timeout of the key exchange timer, the processor can increment a re-association retry counter. If the re-association retry counter is greater than a re-association retry counter threshold, the processor can restart the association process. Otherwise, the processor can re-attempt the re-association process.

As part of a WLAN re-association process between the station and a second access point, the processor can increment a re-association retry counter in response to a re-association failure. If the re-association retry counter is greater than a re-association retry counter threshold, the processor can restart the association process. If the re-association retry counter is not greater than the re-association retry counter threshold, the processor can re-attempt the re-association process.

### BRIEF DESCRIPTION OF THE DRAWINGS

Preferred embodiments of the present invention will be described below in more detail, with reference to the accompanying drawings, in which:

FIG. 1 is a block diagram of a communications system which is useful for understanding the present invention.

FIG. 2 is a flowchart for failure handling during a full security exchange which is useful for understanding the present invention.

FIG. 3 is a flowchart for failure handling during a truncated security exchange which is useful for understanding the present invention.

### DETAILED DESCRIPTION

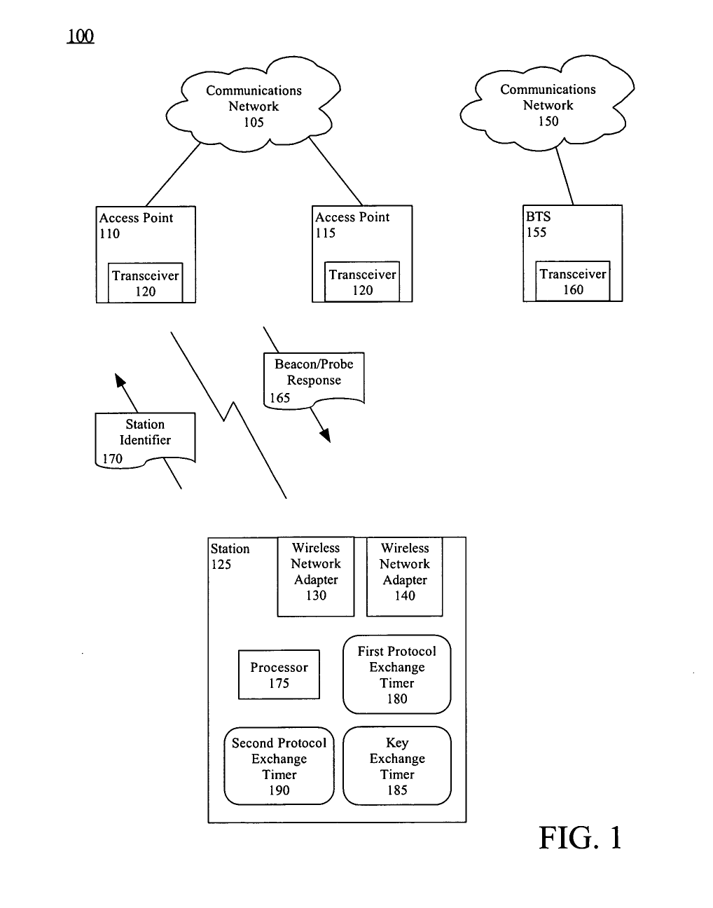

The present invention relates to a method and a system for handling failures during security exchanges between a station and an access point in a wireless communications network. Referring to FIG. 1, a block diagram is shown of a communications system 100 which is useful for understanding the present invention. The communications system 100 can include a communications network 105 having one or more access points 110, 115. The communications network 105 can be, for example, a wireless local area network (WLAN). For instance, the communications network 105 can be implemented in accordance with any of the IEEE 802 wireless network protocols (e.g. 802.11a/b/g/i, 802.15, 802.16, 802.20), Wi-Fi Protected Access (WPA), WPA2, etc. Nonetheless, the invention is not limited in this regard and the communications network 105 can be any communications network capable of supporting wireless communications with a station 125.

The access points 110, 115 each can include a transceiver 120 for wirelessly transmitting and receiving data from the station 125 in order to communicatively connect the station 125 to other nodes of the communications network 105, or any other communication network. For example, the transceivers 120 can support IEEE 802.11 wireless communications, WPA, WPA2, or any other communications protocol implemented in the communications network 105. Each access point 110, 115 can serve multiple stations within a defined network area.

The station 125 can include a wireless network adapter 130 for transmitting and receiving data from the access points 110, 115. As defined herein, a wireless network adapter can be any integrated circuit (IC) or combination of circuit components that implement a communications protocol for wireless communication. For example, the wireless network adapter 130 can support IEEE 802.11 wireless communications, WPA, WPA2, or any other communications protocol implemented in the communications network 105.

In an arrangement in which the station 125 may also communicate over a communications network 150 via a second access point, for instance a base transceiver station (BTS) 155, a second wireless network adapter 140 can be provided with the station 125. For example, the wireless network adapter 130 may be tasked with communicating over the communications network 105, while the second wireless network adapter 140 is tasked with communicating over the communications network 150. In this arrangement, either of the wireless network adapters 130, 140 that are not currently in use can be commanded to enter sleep mode to conserve energy. The station 125 may include antennas (not shown) that are each dedicated to a respective one of the wireless network adapters 130, 140. Alternatively, the wireless network adapters 130, 140 may be connected to one or more shared antennas.

The station 125 also can include a processor 175. The processor 175 can include a central processing unit (CPU), a digital signal processor (DSP), an application specific integrated circuit (ASIC), a programmable logic device (PLD), and/or any other suitable processing device. The processor 175 can be communicatively linked to a first protocol exchange timer 180, a second protocol exchange timer 190 and a key exchange timer 185. Each of the timers 180, 185, 190 can be implemented using known timing circuits, or in any other suitable manner.

When the station 125 enters the network area defined for access point 110, the station 125 can detect a beacon and/or a probe response 165 broadcast by the access point 110. In response to the beacon and/or probe response 165, the station can transmit a station identifier 170 to begin a security exchange.

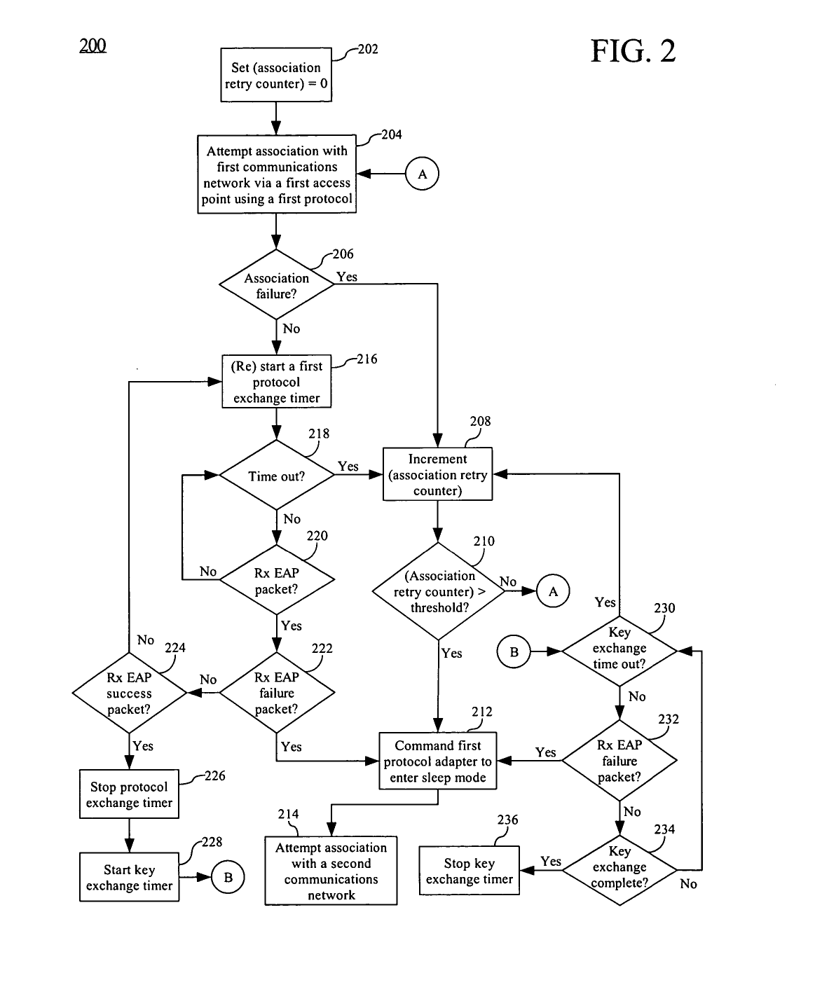

Referring to FIG. 2, a method 200 is presented for implementing a full security exchange in accordance with an embodiment of the present invention. The method 200 can be implemented on the station, or on a device to which the station is communicatively linked. Beginning at step 202, an association retry counter can be set to zero (0). At step 204, the station can attempt an association with a first communications network via a first access point using a first communications protocol. Referring to decision box 206 and step 208, if an association failure occurs, the association retry counter can be incremented, for example by one (1).

Proceeding to decision box 210, a determination can be made whether the association retry counter exceeds a particular threshold. If not, at step 204 another attempt can be made to associate with the first communications network. If the association retry counter does exceed the threshold, this can be indicative of an association hindrance. Accordingly, at step 212, the wireless network adapter tasked with implementing the first communications protocol can enter sleep mode to conserve power on the station. For example, one or more integrated circuits (ICs) within the wireless network adapter can be placed in sleep mode. At step 214, a second wireless network adapter tasked with implementing a second communications protocol can be activated to attempt to log the station onto a second communications network. For example, briefly referring to FIG. 1, the wireless network adapter 140 can implement a cellular communications protocol, such as GSM, to communicate with the communications network 150 via the BTS 155. Referring back to FIG. 2, the station can restart the method 200 at timed intervals while a beacon or probe response is detected.

Referring again to decision box 206 and to step 216, if there is not an association failure, a first protocol exchange timer can be started. Referring to decision box 218 and decision box 220, while the first protocol exchange timer has not timed out, the process can monitor whether an extensible authentication protocol (EAP) packet is received from the access point. Examples of EAP packets are EAP failure packets and EAP success packets. An EAP failure packet can indicate that the station was not authenticated by the access point, whereas an EAP success packet can indicate that the station was authenticated.

Referring to decision box 218, if the first protocol exchange timer times out before the EAP packet is received, the process can proceed to step 208, where the association retry counter is incremented. Referring again to decision box 210 and step 204, the station can again attempt to associate with the first communications network if the association counter is below the threshold. Alternatively, at step 212 the first wireless network adapter can enter sleep mode. At step 214, the second wireless network adapter tasked with implementing the second communications protocol can be activated.

Referring again to step 220, if the EAP packet is received from the access point, a determination can be made whether the EAP packet is a failure packet or a success packet, as shown in decision boxes 222 and 224. If the received EAP packet is a failure packet, the first wireless network adapter can enter sleep mode, as shown in step 212. If the received EAP packet is neither a failure packet nor a success packet, for example the EAP packet is an EAP request or EAP response frame, the first protocol exchange timer can be restarted, as shown in step 216, and the station can wait for a success or failure EAP packet to be received, at least until the first protocol exchange timer times out.

Referring again to decision box 224, if a success EAP packet is received, at step 226 the first protocol exchange timer can be stopped. Proceeding to step 228, a key exchange timer then can be started while the station and access point implement a key exchange. Referring to decision boxes 230, 232 and 234, if the key exchange timer times out before an EAP failure packet is received from the access point, or before the key exchange is complete, the association retry counter can be incremented at step 208.

Again referring to decision box 210 and step 212, if the association retry counter is greater than the threshold, the wireless network adapter can enter sleep mode, and an attempt can be made to associate with the second communications network, as shown in step 214. Otherwise, the process can continue at step 204 with another association attempt being made. Referring to decision box 232 and step 212, the receipt of a failure packet after the key exchange timer has been started also can trigger the first wireless network adapter to enter sleep mode.

Referring to decision box 234, once the key exchange is complete the key exchange timer can be stopped, as shown in step 236. At this time the access point can provide WLAN access to the station.

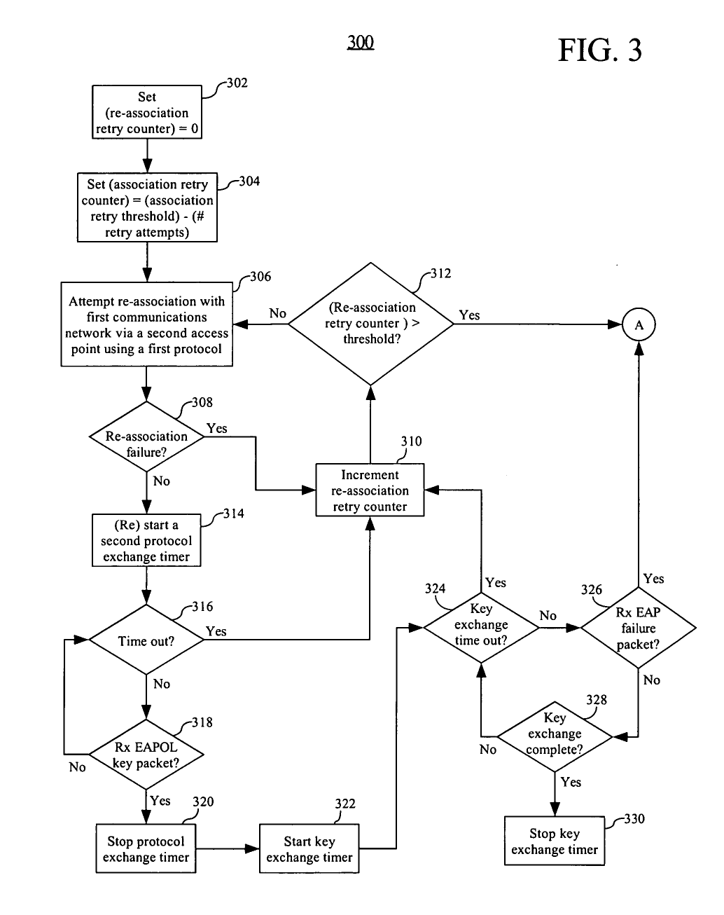

Referring again to FIG. 1, as the station 125 moves beyond the network area defined for access point 110, the station 125 can be automatically handed over to a next access point, such as access point 115. At this point, a truncated security exchange can be implemented to re-associate the station with the WLAN. Referring to FIG. 3, a method 300 is presented for implementing a truncated security exchange in accordance with an embodiment of the present invention.

At step 302, a re-association retry counter can be set to zero (0). At step 304, the association retry counter previously discussed in the method 200 can be set to control the number of association retry attempts. In one arrangement, the association retry counter can be set to a value of the association retry threshold—also discussed in the method 200—minus the quantity of the desired number of retry attempts. For example, if one retry attempt is desired, the association retry counter can be set to the association retry threshold minus one (1).

At step 306 the station can attempt to re-associate with the first communication network via the second access point, using the first communications protocol. Referring to decision box 308, if a re-association failure occurs, the re-association retry counter can be incremented, as shown in step 310, for example by one. Referring to decision box 312, if the re-association retry counter is not greater than a threshold, re-association via the second access point once again can be attempted, as shown in step 306. If, however, the re-association retry counter is greater than the threshold, the process can proceed back to step 204 of the method 200 presented in FIG. 2, and a full security exchange can be implemented.

Referring again to decision box 308, if a re-association failure does not occur, a second protocol exchange timer can be started, as shown in step 314. The second protocol exchange timer can be, for instance, a timer for receiving a first extensible authentication protocol over LAN (EAPOL) key packet from the second access point. Continuing to decision box 316 and decision box 318, if the second protocol exchange timer times out before an EAPOL key packet is received, the process can proceed to step 310 and decision box 312 where the re-association retry counter is incremented and evaluated. Since the truncated exchange does not include an 802.1× authentication using extensible authentication protocol with transport layer security (EAP-TLS), the expected EAPOL key packet from the second access point can include a first (EAPOL) key of the four way key handshake. If the EAPOL key packet is received, at step 320 the second protocol exchange timer can be stopped. Continuing to step 322, the key exchange timer can be started. Referring to decision boxes 324, 326 and 328, if the key exchange timer times out before an EAP failure packet is received or the key exchange is complete, the process can proceed to step 310 and decision box 312 where the re-association retry counter is incremented and evaluated.

Referring to decision box 326, if an EAP failure packet is received, the process can proceed back to step 204 of the method 200 presented in FIG. 2, and a full security exchange can be implemented. Referring to decision box 328, if the key exchange completes before the key exchange timeout and an EAP failure packet has not been received, the key exchange timer can be stopped, as shown in step 330. At this time the access point can provide WLAN access to the station.

The present invention can be realized in hardware, software, or a combination of hardware and software. The present invention can be realized in a centralized fashion in one system, or in a distributed fashion where different elements are spread across several interconnected systems. Any kind of processing device or other apparatus adapted for carrying out the methods described herein is suited. A typical combination of hardware and software can be a processing device with an application that, when being loaded and executed, controls the processing device such that it carries out the methods described herein.

The present invention also can be embedded in an application program product, which comprises all the features enabling the implementation of the methods described herein, and which when loaded in a processing device is able to carry out these methods. Application program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for handling a security exchange failure between a station having a wireless network adapter and a first access point of a wireless local area network (WLAN), comprising:
as part of a WLAN association process, transmitting from the station to the first access point a message comprising a station identifier;
starting a first protocol exchange timer;
responsive to a timeout of the first protocol exchange timer, incrementing an association retry counter;
restarting the association process if the association retry counter is not greater than a retry counter threshold; and
commanding the wireless network adapter to enter sleep mode if the association retry counter is greater than the retry counter threshold.

2. The method according to claim 1, further comprising incrementing the association retry counter responsive to receiving a message comprising an association failure identifier or not receiving a response from the first access point.

3. The method according to claim 1, further comprising commanding the wireless network adapter to enter sleep mode in response to receiving an extensible authentication protocol (EAP) failure packet.

4. The method according to claim 3, further comprising attempting an association with a second communications network in response to receiving the EAP failure packet.

5. The method according to claim 1, further comprising stopping the first protocol exchange timer in response to receiving an EAP success packet.

6. The method according to claim 1, further comprising starting a key exchange timer in response to receiving an EAP success packet.

7. The method according to claim 6, further comprising incrementing the association retry counter in response to a timeout of the key exchange timer.

8. The method according to claim 1, further comprising:
as part of a WLAN re-association process between the station and a second access point, starting a second protocol exchange timer;
responsive to a timeout of the second protocol exchange timer, incrementing a re-association retry counter;
restarting the association process if the re-association retry counter is greater than a re-association retry counter threshold; and
re-attempting the re-association process if the re-association retry counter is not greater than the re-association retry counter threshold.

9. A station comprising:
a wireless network adapter that transmits from the station to a first access point a message comprising a station identifier, the message being transmitted as part of a WLAN association process;
a first protocol exchange timer; and
a processor that increments an association retry counter responsive to a timeout of the first protocol exchange timer;
wherein the processor restarts the association process if the association retry counter is not greater than a retry counter threshold, and the processor signals the wireless network adapter to enter sleep mode if the association retry counter is greater than the retry counter threshold.

10. The station of claim 9, wherein the processor increments the association retry counter responsive to receiving a message comprising an association failure identifier, or not receiving a response from the first access point.

11. The station of claim 9, wherein the processor signals the wireless network adapter to enter sleep mode in response to receiving an EAP failure packet from the first access point.

12. The station of claim 11, wherein the station attempts to associate with a second communications network in response to receiving the EAP failure packet.

13. The station of claim 9, wherein the processor stops the first protocol exchange timer in response to receiving an EAP success packet from the first access point.

14. The station of claim 9, wherein the processor starts a key exchange timer in response to receiving an EAP success packet from the first access point.

15. The station of claim 14, wherein the processor increments the association retry counter in response to a timeout of the key exchange timer.

16. The station of claim 9, wherein the processor starts a second protocol exchange timer as part of a WLAN re-association process between the station and a second access point, increments a re-association retry counter in response to a timeout of the second protocol exchange timer, restarts the association process if the re-association retry counter is greater than a re-association retry counter threshold, and re-attempts the re-association process if the re-association retry counter is not greater than the re-association retry counter threshold.

17. The station of claim 9, wherein the processor starts a second protocol exchange timer as part of a WLAN re-association process between the station and a second access point, starts a key exchange timer in response to receiving an extensible authentication protocol over LAN (EAPOL) key packet prior to a timeout of the second protocol exchange timer, increments a re-association retry counter responsive to a timeout of the key exchange timer, restarts the association process if the re-association retry counter is greater than a re-association retry counter threshold, and re-attempts the re-association process if the re-association retry counter is not greater than the re-association retry counter threshold.

18. The station of claim 9, wherein the processor increments a re-association retry counter in response to a re-association failure as part of a WLAN re-association process between the station and a second access point, restarts the association process if the re-association retry counter is greater than a re-association retry counter threshold, and re-attempts the re-association process if the re-association retry counter is not greater than the re-association retry counter threshold.

19. A machine readable storage, having stored thereon a computer program having a plurality of code sections executable by a machine for causing the machine to perform the steps of:
as part of a WLAN association process, transmitting from a station to a first access point a message comprising a station identifier;
starting a first protocol exchange timer;
responsive to a timeout of the first protocol exchange timer, incrementing an association retry counter;
restarting the association process if the association retry counter is not greater than a retry counter threshold; and
commanding the wireless network adapter to enter sleep mode if the association retry counter is greater than the retry counter threshold.

20. The machine readable storage of claim 19, further causing the machine to perform the steps of:
as part of a WLAN re-association process between the station and a second access point, starting a second protocol exchange timer;
responsive to a timeout of the second protocol exchange timer, incrementing a re-association retry counter;
restarting the association process if the re-association retry counter is greater than a re-association retry counter threshold; and
re-attempting the re-association process if the re-association retry counter is not greater than the re-association retry counter threshold.
